(19) United States
(12) Patent Application Publication
(10) Pub. No.: US 2004/0013429 A1
(43) Pub. Date: Jan. 22, 2004

(54) Power equalization in optical switches

(76) Inventors: Marcus Duelk, Atlantic Highlands, NJ (US); Jurgen Gripp, Cranford, NJ (US)

Correspondence Address: MENDELSOHN AND ASSOCIATES PC, 1515 MARKET STREET, SUITE 715, PHILADELPHIA, PA, 19102, US

(21) Appl. No.: 10/199,639

(22) Filed: Jul. 19, 2002

(51) Int. Cl. H04J 14/00

(52) U.S. Cl. 398/45; 330/45

(57) ABSTRACT

An optical switch configured to reduce packet-to-packet optical power variation corresponding to different switch channels. The optical switch includes a plurality of optical amplifiers coupled to the input or output ports of an optical switch fabric (OSF), e.g., an arrayed waveguide grating. Each amplifier may be a semiconductor optical amplifier configured to operate in the saturated regime. In addition, the maximum output power of each amplifier may be set to a different value related to the insertion loss in the OSF. As a result, at each receiver corresponding to an output port of the OSF, the optical power corresponding to data packets arriving from different input ports may be substantially equalized. Such equalization may reduce the number of bit errors in the switch.

### BACKGROUND OF THE INVENTION

1. Field of the Invention

The present invention relates to optical communication equipment.

2. Description of the Related Art

FIG. 1 shows a representative switch 100 of the prior art for routing data in a communication system. Switch 100 is a (2N+1)×(2N+1) switch that can route data from any one of its 2N+1 inputs to any one of its 2N+1 outputs. Switch 100 comprises a (2N+1)×(2N+1) arrayed waveguide grating (AWG) 102, 2N+1 transmitter cards 110 (only three of which are shown) coupled to input ports of AWG 102, and 2N+1 receivers 120 coupled to output ports of AWG 102. Each transmitter card 110 is configured to receive a corresponding electrical stream of data, convert it into an optical signal, and send that optical signal to AWG 102. AWG 102 is a solid state device configured to redirect light entering any one of the input ports to a selected output port based on its wavelength. Each receiver 120 is configured to receive an optical signal from one of the output ports of AWG 102 and convert it back into a corresponding electrical data stream.

Each transmitter card 110 comprises a tunable laser 112 and a modulator 114. Laser 112 feeds an optical carrier signal into modulator 114. Modulator 114 modulates the carrier signal with data based on the corresponding electrical input data stream to produce an optical data-modulated output signal of the respective transmitter card 110. Each transmitter card 110 can be configured to send data to any chosen receiver 120 by setting the wavelength of laser 112 to the value for the corresponding output port of AWG 102. Depending on the implementation of AWG 102, lasers 112 corresponding to different input ports of AWG 102 may be tunable over different wavelength ranges.

One problem associated with switch 100 is related to insertion losses in AWG 102. For example, different optical paths in AWG 102, e.g., corresponding to different input ports and a selected output port, may have different insertion losses (defined as signal attenuation in the AWG). Consequently, average power of an optical signal at the receiver coupled to the selected output port may vary significantly, e.g., from packet to packet, depending on the originating input port. Such variation may induce bit errors at the receiver.

### SUMMARY OF THE INVENTION

Certain embodiments of the present invention provide an optical switch configured to reduce packet-to-packet optical power variation corresponding to different switch channels. The optical switch includes a plurality of optical amplifiers coupled to the input or output ports of an optical switch fabric (OSF), e.g., an arrayed waveguide grating. Each amplifier may be a semiconductor optical amplifier configured to operate in the saturated regime. In addition, the maximum output power of each amplifier may be set to a different value related to the insertion loss in the OSF. As a result, at each receiver corresponding to an output port of the OSF, the optical power corresponding to data packets arriving from different input ports is equalized. Such equalization may reduce the number of bit errors in the switch.

According to one embodiment, the present invention is an apparatus comprising: (A) an optical switch fabric (OSF) having M input ports and M output ports and configured to route optical signals from its input ports to its output ports, where M is an integer greater than one; and (B) one or more of M transmitters and M receivers, wherein: if the apparatus comprises M transmitters, then each transmitter is configured to generate an optical signal modulated with data, wherein an input optical signal applied to a corresponding input port of the OSF is based on the generated optical signal; and if the apparatus comprises M receivers, then each receiver is configured to receive an optical signal modulated with data, wherein the received signal is based on an output optical signal from a corresponding output port of the OSF; and (C) at least M optical amplifiers configured to reduce power variation of received optical signals corresponding to output optical signals from the OSF.

According to another embodiment, the present invention is a method of transmitting data, comprising the steps of: (a) applying one or more input optical signals modulated with data to an optical switch fabric (OSF), wherein the OSF has M input ports and M output ports, where M is an integer greater than one; (b) routing the one or more input optical signals using the OSF to generate one or more output optical signals; and (c) optically amplifying, using at least M optical amplifiers, one or more optical signals to reduce power variation of received optical signals corresponding to the one or more input optical signals, wherein the received optical signals are based on the one or more output optical signals.

### BRIEF DESCRIPTION OF THE DRAWINGS

Other aspects, features, and advantages of the present invention will become more fully apparent from the following detailed description, the appended claims, and the accompanying drawings in which:

FIG. 1 shows a prior art switch for routing data signals;

FIGS. 2A-B illustrate insertion loss in a representative 33×33 cyclic AWG that may be used in the switch of FIG. 1;

FIG. 3 depicts an illustrative sequence of packets arriving at a receiver in the switch of FIG. 1;

FIGS. 4A-C show switches for routing data signals according to different embodiments of the present invention;

FIG. 5 shows a representative amplification curve for an optical amplifier that may be used in the switches of FIG. 4 according to one embodiment of the present invention;

FIG. 6 illustrates a representative spectral characteristic of an erbium-doped fiber amplifier (EDFA) that may be used in the switches of FIG. 4 according to one embodiment of the present invention;

FIG. 7 illustrates representative spectral characteristics of a semiconductor optical amplifier (SOA) that may be used in the switches of FIG. 4 according to another embodiment of the present invention;

FIG. 8 illustrates possible configurations of different optical amplifiers in the switches of FIG. 4; and

FIG. 9 illustrates average power in the wavelength domain at different receivers in the switches of FIG. 4, which employ optical amplifiers configured according to FIG. 8.

### DETAILED DESCRIPTION

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments.

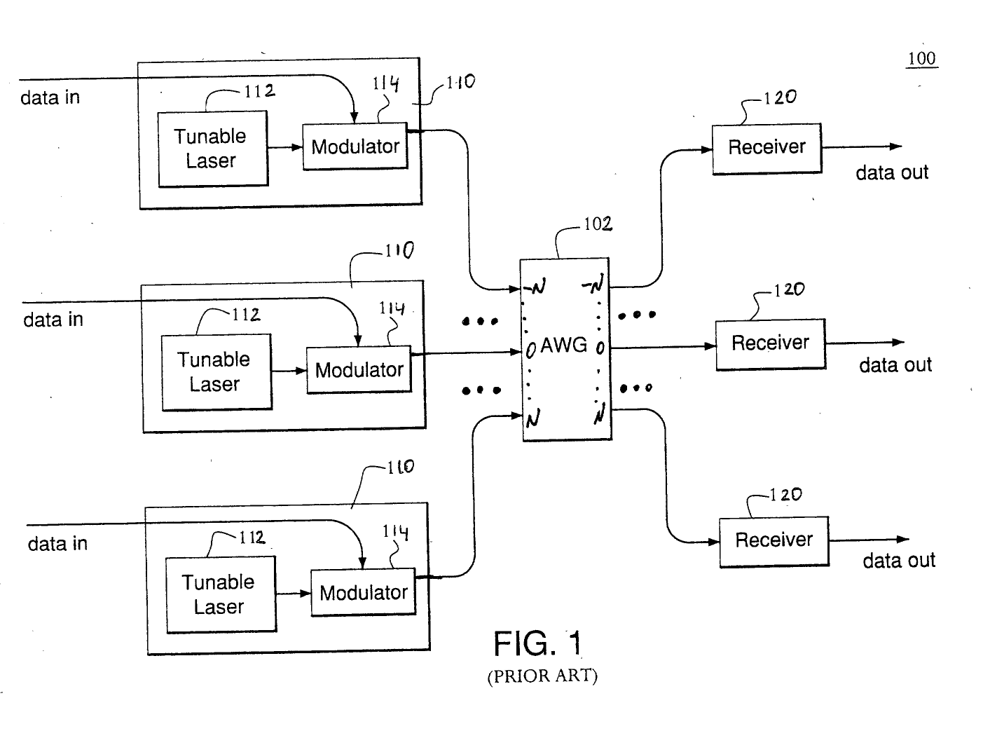

Before embodiments of the present invention are described in detail, different factors limiting the performance of prior art switch 100 of FIG. 1 are briefly characterized.

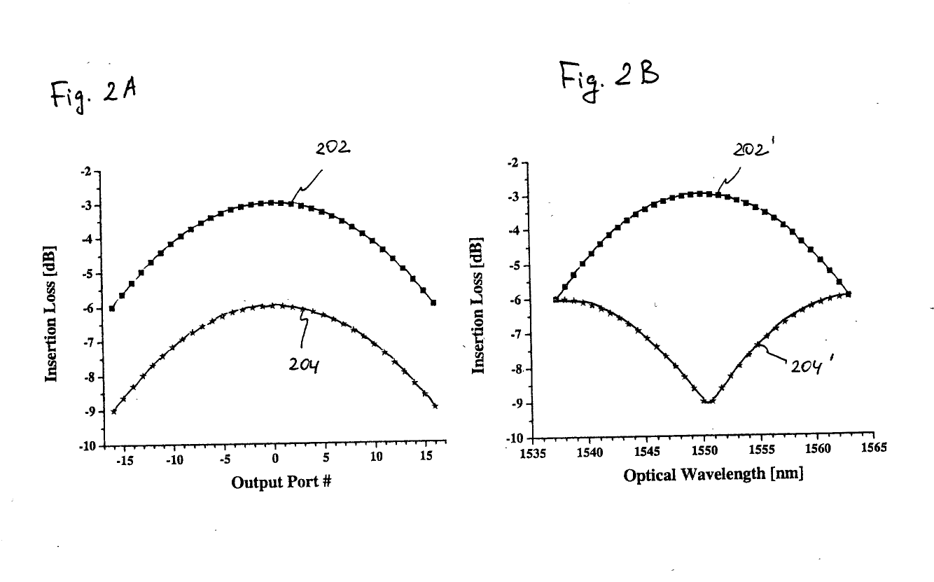

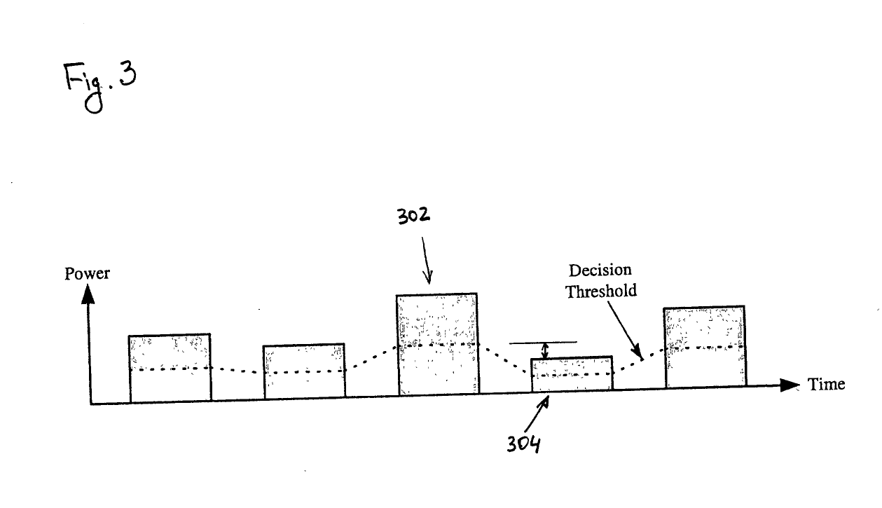

FIGS. 2A-B illustrate insertion loss in a representative 33×33 (N=16) cyclic AWG 102. The following port numbering convention is employed to describe the operation of the AWG. The 33 input/output ports are numbered from −16 to 16, such that ports −16 and 16 correspond to opposite edges of the AWG, and port 0 corresponds to the center.

In FIG. 2A, curve 202 shows the insertion loss between input port 0 and the 33 different output ports. Similarly, curve 204 shows the insertion loss between input port 16 and the 33 output ports. In a typical cyclic AWG, curve 204 will also correspond to the insertion loss between input port −16 and the 33 output ports. In addition, the curves corresponding to the other input ports will typically have shapes similar to those of curves 202 and 204 and lie in between those two curves. In particular, as the input port number increases from 1 to 15, the corresponding curve will lie progressively closer to curve 204. Similarly, as the input port number decreases from −1 to −15, the corresponding curve will also lie progressively closer to curve 204.

FIG. 2B shows curves 202 and 204 that represent the data of curves 202 and 204, respectively, of FIG. 2A in the wavelength domain. For example, in the 33×33 AWG illustrated by FIG. 2B, an AWG channel for routing optical signals between the n-th input port (−N n N) and the n-th output port is designed around 1550.0 nm. A next AWG channel, e.g., between the n-th input port to the (n+1)-th output port, is spectrally offset from 1550.0 nm by about 0.8 nm. In addition, the AWG channels are arranged in a cyclic manner such that, for example, the AWG channel between input port 16 and output port −16 is designed around 1550.8 nm, whereas the AWG channel between input port −16 and output port 16 is designed around 1549.2 nm. Consequently, the 1089 (=33×33) AWG channels can be accommodated using 33 wavelengths in the range from about 1537 nm to 1563 nm.

As illustrated by FIGS. 2A-B, the closer an input or output port is to an edge of the AWG, the higher is the associated insertion loss. In particular, a relatively high loss of about −9 dB is encountered for transmission between any two edge ports (n=±16), whereas a relatively low loss of about −3 dB is encountered for transmission between the two center ports (n=0). In general, insertion loss in an AWG may be a rather complex function of the routing path, possibly leading to even larger power variation at the receiver as further illustrated below.

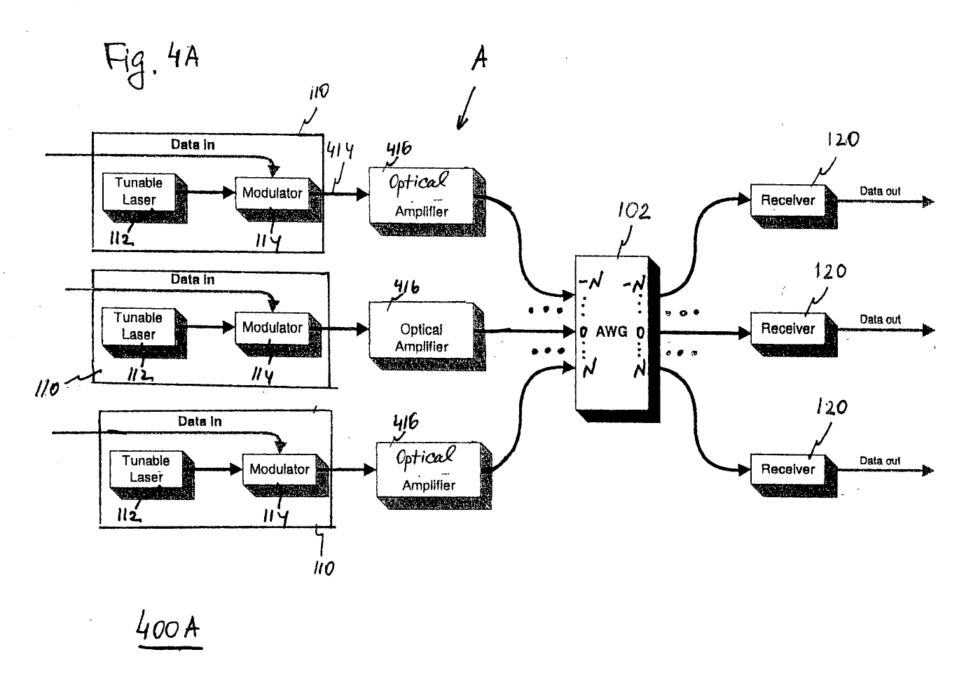

FIG. 3 shows an illustrative sequence of data packets arriving at the receiver coupled to a selected output port (e.g., any one receiver 120 in switch 100). As shown in FIG. 3, signal power may vary from packet to packet. For example, packet 302 received through an AWG channel with a relatively low insertion loss has a relatively high power. On the other hand, packet 304 received through an AWG channel with a relatively high insertion loss has a relatively low power. As a result, the decision threshold (defined as a power level at which the distinction between the logical “zeros” and logical “ones” is drawn) has to be dynamically adjusted from packet to packet. In addition, if such adjustment is not sufficiently fast, bit errors may arise from misinterpretation of bits in at least a leading portion of a packet. For example, if the decision threshold for packet 304 remains at the level corresponding to the preceding packet 302, all bits in packet 304 are interpreted as logical “zeros” and the corresponding data are lost. Furthermore, adjustment of the decision threshold at the receiver has an inherent disadvantage of generating AC coupling with the data. As a result, long sequences of logical “ones” or “zeros” that are responsible for a low frequency component in the signal spectrum may suffer from additional penalties associated with such AC coupling.

Besides the AWG insertion loss illustrated by FIGS. 2 and 3, there may be additional sources of power variation at each receiver 120. One of such sources is related to the performance of lasers 112. For example, for a given AWG channel, the output power of the corresponding laser 112 operating at the corresponding wavelength may change over time, e.g., due to a thermal drift. In addition, the wavelength of the laser may become misaligned with respect to the AWG channel. Furthermore, for a set of AWG channels having a common output port and different input ports, power levels of different lasers 112, each operating at a different wavelength corresponding to the common output port, may vary from laser to laser. The manifestation of these sources of power variation at the receiver is similar to the behavior illustrated by FIG. 3.

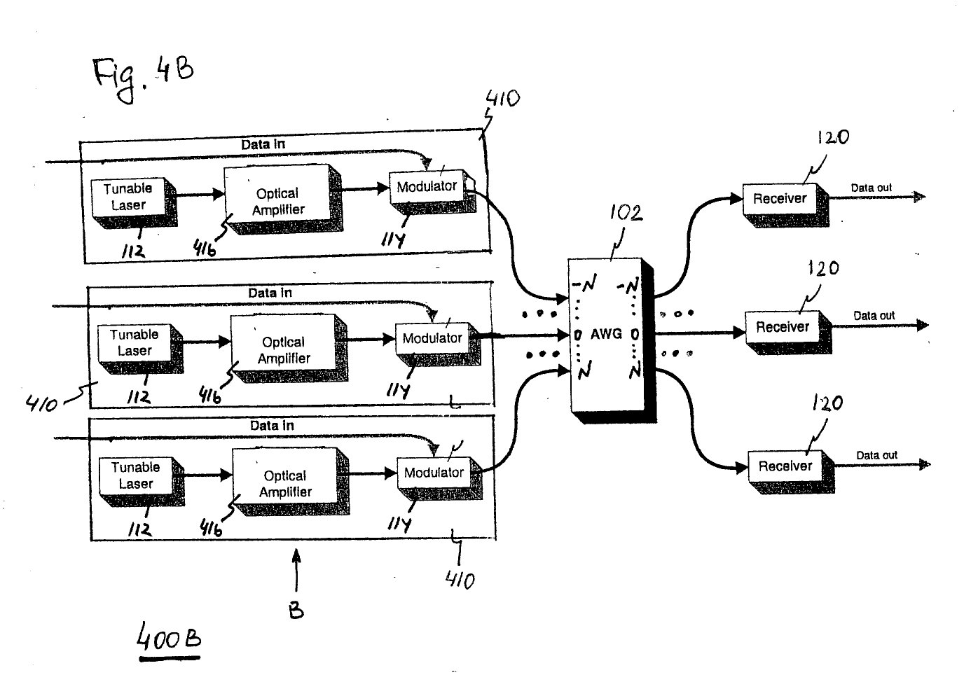

FIGS. 4A-C show switches 400A-C according to different embodiments of the present invention. Switches 400A-C are similar to switch 100 of FIG. 1 except that each switch 400A-C includes a plurality of optical amplifiers 416 in addition to the components of switch 100. In different embodiments, individual amplifiers 416 may be placed at one of three different locations designated A, B, and C and corresponding to FIGS. 4A, 4B, and 4C, respectively. For example, in switch 400A of FIG. 4A, each amplifier 416 is placed at location A, i.e., between transmitter card 110 and AWG 102. Alternatively, a set of differently designed transmitter cards, each including in series: laser 112, modulator 114, and amplifier 416, may be used in switch 400A. In switch 400B of FIG. 4B, each amplifier 416 is placed at location B, i.e., within a transmitter card 410 between laser 112 and modulator 114. In addition, in switch 400C of FIG. 4C, each amplifier 416 is placed at location C, i.e., between an output port of AWG 102 and corresponding receiver 120. Alternatively, switch 400C may be configured with a set of receiver cards, each having amplifier 416 and receiver 120. In other embodiments, different optical amplifiers 416 may or may not be placed at analogous locations and/or one or more optical paths from transmitter cards to receivers may have more than one optical amplifier 416. For example, in one embodiment, each input port of AWG 102 may be coupled to either a transmitter card 110/amplifier 416 pair (as in switch 400A) or transmitter card 410 (as in switch 400B). Furthermore, in one embodiment, a switch may have optical amplifier 416 at each location A and at each location C.

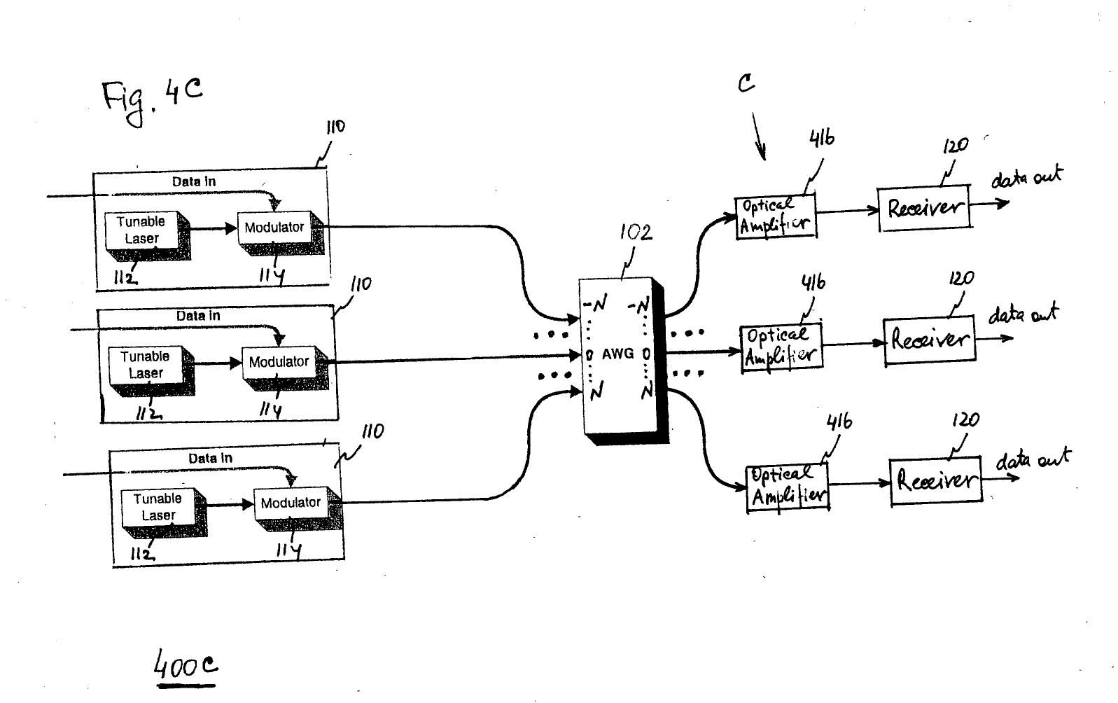

FIG. 5 shows a representative amplification curve for amplifier 416 according to one embodiment of the present invention. Amplifier 416 can operate in two regimes, i.e., a linear regime and a saturated regime. In the linear regime, the output power of amplifier 416 increases approximately linearly with the input power, whereas in the saturated regime, the output power of amplifier 416 is substantially independent of the input power and corresponds to Pₘₐₓ. As further illustrated in FIG. 5, when amplifier 416 operates in the saturated regime, input power fluctuations do not have a significant effect on the output power. In one embodiment, the value of Pₘₐₓ for amplifier 416 is wavelength independent. The following description relates to representative implementations of amplifier 416 with such spectral characteristics.

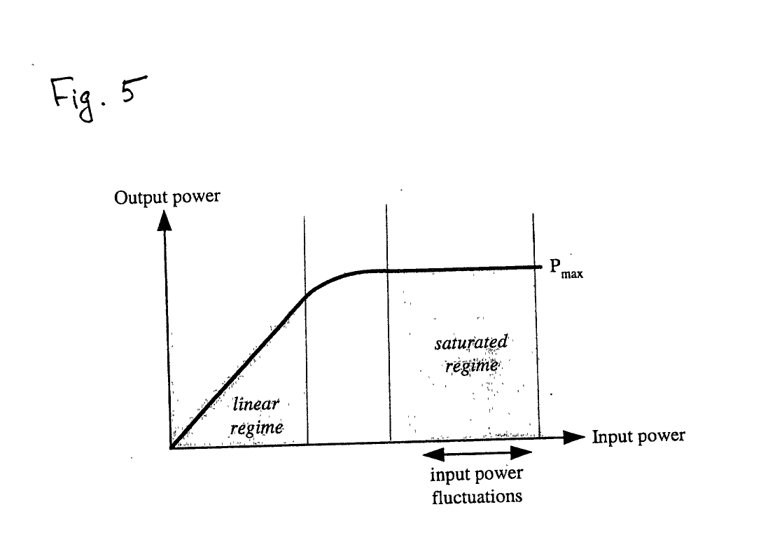

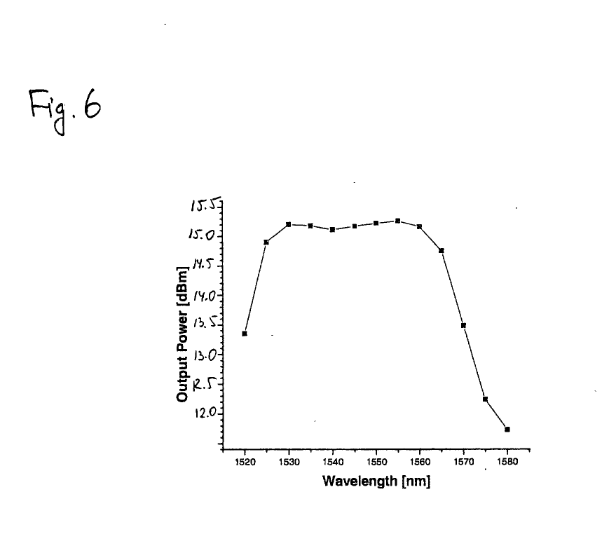

FIG. 6 illustrates the representative wavelength dependence Of Pₘₐₓ in an erbium-doped fiber amplifier (EDFA) that may be used as amplifier 416 in one embodiment of the present invention. As can be seen in FIG. 6, the EDFA may have a relatively flat gain (e.g., to within 0.2 dB) in a spectral band that is approximately 30 nm wide and extends from about 1530 nm to about 1560 nm. Erbium-doped optical amplifiers are well known to the persons skilled in the art and may be configured to operate using either an L- or C-band and typically have a time constant on the order of 50 ms.

FIG. 7 illustrates representative spectral characteristics of a semiconductor optical amplifier (SOA) that may be used as amplifier 416 in another embodiment of the present invention. In particular, curve 702 is the spectral characteristic of Pₘₐₓ in an SOA obtained using a fixed value of injection current. Curve 702 has a parabola-like shape with a maximum of about 13 dBm at 1557 nm. The output power is relatively flat around the maximum, e.g., in the range from 1550 to 1565 nm. In different implementations, the SOA may be designed to have a gain maximum anywhere between about 1300 and 1620 nm by engineering its semiconductor bandgap and/or band-structure.

It is known in the art that SOAs have very fast gain dynamics characterized by a typical gain recovery time and carrier injection time on the order of 100 ps and 1 ns, respectively. Consequently, the gain of an SOA can be adjusted quickly to maintain a chosen constant Pₘₐₓ value for different data packets corresponding to different wavelengths. Curves 704 and 706 in FIG. 7 show representative spectral characteristics of Pₘₐₓ that can be obtained in the SOA using a variable value of injection current. More specifically, in the operational modes corresponding to curves 704 or 706, the SOA is configured to change its injection current (and therefore the gain and output power) based on the wavelength of the amplified optical signal, e.g., signal 414 in switch 400 of FIG. 4. In this mode, the SOA can produce a wider spectral region of steady output power than that for curve 702, but at the expense of the power level. For example, curve 704 corresponds to a steady output power of 11.5 dBm achieved over the range of 1530 to 1584 nm. Curve 706 illustrates that an even wider spectral coverage (e.g., from 1522 to 1594 nm) may be implemented for the correspondingly smaller value of steady output power (e.g., 10 dBm).

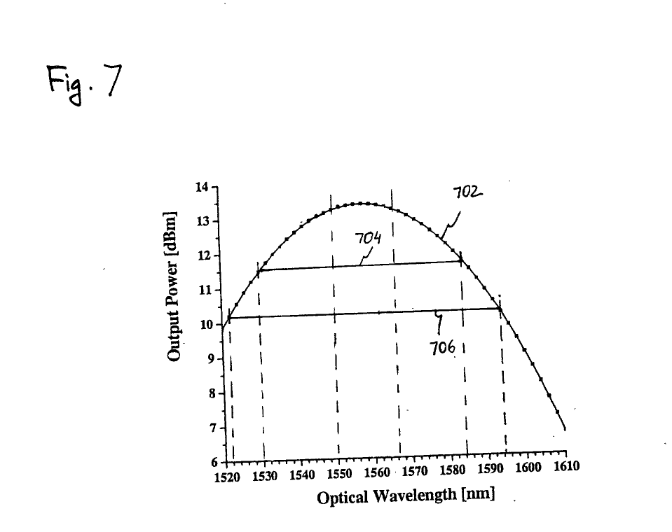

FIG. 8 illustrates possible relative configurations of amplifiers 416 at locations A or B in switch 400 (FIG. 4). More specifically, FIG. 8 shows the value of Pₘₐₓ for different amplifiers 416 as a function of the corresponding input port number. In one configuration represented by curve 802, the value of Pₘₐₓ is independent of the port number and is set to about 10 dBm. In another configuration represented by curve 804, Pₘₐₓ is set to a minimum value of about 10 dBm for amplifier 416 corresponding to input port 0. For other amplifiers 416, Pₘₐₓ is set such that higher values of Pₘₐₓ correspond to higher absolute port numbers, with the Pₘₐₓ value for the amplifier corresponding to port ±16 to be about 13 dBm. In a preferred configuration, the shape of curve 804 corresponds to a mirror image of curve 202 in FIG. 2.

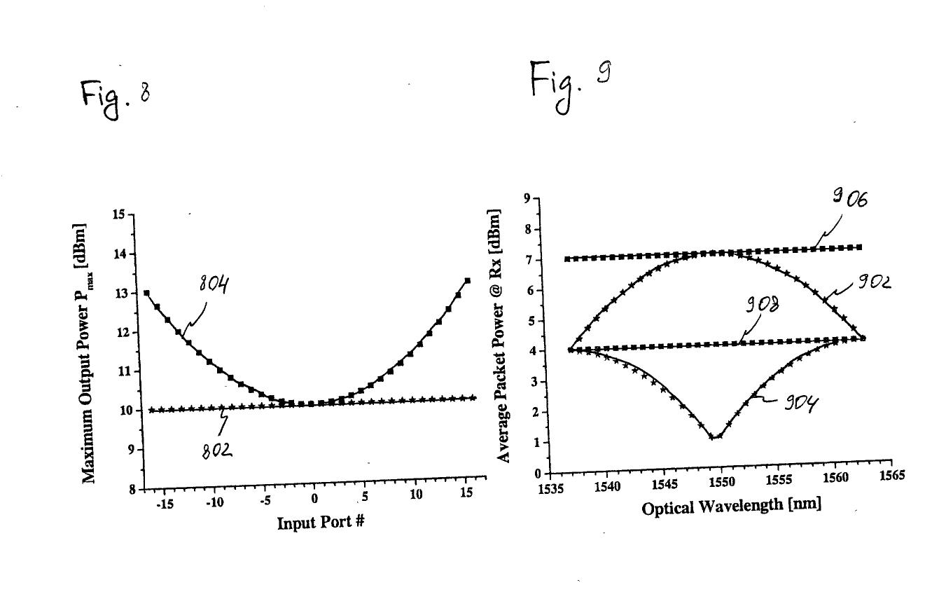

FIG. 9 illustrates (in the wavelength domain) average power at different receivers 120 in switch 400, in which AWG 102 is characterized by insertion loss illustrated in FIG. 2 and amplifiers 416 are configured as illustrated in FIG. 8. In particular, curve 902 shows the average power for data packets routed through different input ports and received at output port 0 when amplifiers 416 are configured according to curve 802 in FIG. 8. Similarly, curve 904 shows the average power for data packets routed through different input ports and received at output port ±16, and for the same configuration of amplifiers 416 (i.e., according to curve 802). Furthermore, curve 906 shows the average power for data packets routed through different input ports and received at output port 0 when amplifiers 416 are configured according to curve 804 in FIG. 8. Similarly, curve 908 shows the average power for packets routed through different input ports and received at output port ±16, and for the configuration of amplifiers 416 according to curve 804. In different configurations, the equalized power at different receivers 120 in switch 400 may be different (e.g., as illustrated by curves 906 and 908 in FIG. 9) or the same (e.g., corresponding to curve 908 at each receiver).

As seen in FIG. 9, the configuration of amplifiers 416 corresponding to curve 804 reduces the deleterious effects of the AWG insertion loss by equalizing the signal power at each receiver 120 in switch 400. In addition, because each amplifier 416 is configured to operate in the saturated regime, the effects of thermal drift are reduced in either configuration (i.e., corresponding to curve 802 or 804). As a result, signal power variations at each receiver (and consequently the number of bit errors) may be reduced in switch 400 compared to that in prior art switch 100.

In one embodiment, configurations of amplifiers 416 placed at locations C in switch 400 may be selected to perform post-compensation (as opposed to pre-compensation in locations A and B) of routing losses in AWG 102. For example, amplifier 416 at each location C may be configured such that power variations corresponding to different input ports fall within the power range corresponding to the saturated regime (see FIG. 5). Alternatively, amplifier 416 at each location C may be an SOA configured to operate with variable injection current such that power is equalized among packets corresponding to different input ports and having the corresponding different wavelengths. Placing each amplifier 416 at location C may have a benefit of reducing the component of power variation corresponding to laser wavelength misalignment with respect to the AWG channels.

Although this invention has been described for optical switches employing AWGs, those skilled in the art can appreciate that the invention can also be applied to optical switches employing other types of optical switch fabrics. The number of ports in the AWG may be odd or even. In different embodiments, one or more lasers/amplifiers may be configured with an optical filter, e.g., to achieve a desirable spectral output profile. The type and/or location of an optical amplifier in a switch may be selected, e.g., based on the modulation format (for example, phase modulation, return-to-zero amplitude modulation, etc.), bit rate, the type of the optical switch fabric, etc. The gain of a selected optical amplifier may be set to 0 dB if, e.g., the power at the corresponding receiver is above that receiver's sensitivity threshold. In addition, the switch may be designed to be reconfigurable, e.g., to allow location change for the optical amplifiers within the switch.

While this invention has been described with reference to illustrative embodiments, this description is not intended to be construed in a limiting sense. Various modifications of the described embodiments, as well as other embodiments of the invention, which are apparent to persons skilled in the art to which the invention pertains are deemed to lie within the principle and scope of the invention as expressed in the following claims.

Although the steps in the following method claims, if any, are recited in a particular sequence with corresponding labeling, unless the claim recitations otherwise imply a particular sequence for implementing some or all of those steps, those steps are not necessarily intended to be limited to being implemented in that particular sequence.

What is claimed is:

1. An apparatus comprising:
(A) an optical switch fabric (OSF) having M input ports and M output ports and configured to route optical signals from its input ports to its output ports, where M is an integer greater than one; and
(B) one or more of M transmitters and M receivers, wherein:
if the apparatus comprises M transmitters, then each transmitter is configured to generate an optical signal modulated with data, wherein an input optical signal applied to a corresponding input port of the OSF is based on the generated optical signal; and
if the apparatus comprises M receivers, then each receiver is configured to receive an optical signal modulated with data, wherein the received signal is based on an output optical signal from a corresponding output port of the OSF; and
(C) at least M optical amplifiers configured to reduce power variation of received optical signals corresponding to output optical signals from the OSF.

2. The invention of claim 1, wherein the apparatus comprises M transmitters and M receivers.

3. The invention of claim 1, wherein the apparatus comprises M transmitters, where the M receivers are located remotely from the apparatus.

4. The invention of claim 1, wherein the apparatus comprises M receivers, where the M transmitters are located remotely from the apparatus.

5. The invention of claim 1, wherein an optical amplifier is coupled between each transmitter and the corresponding input port of the OSF.

6. The invention of claim 1, wherein each transmitter comprises a tunable laser, an optical amplifier, and a modulator, wherein:
the optical amplifier is coupled between the tunable laser and the modulator; and
the modulator is configured to (i) modulate the output of the optical amplifier with data and (ii) apply the resulting signal to the corresponding input port of the OSF.

7. The invention of claim 1, wherein:
for one or more input ports of the OSF, an optical amplifier is coupled between the corresponding transmitter and the input port of the OSF; and
for one or more other input ports of the OSF, the corresponding transmitter comprises a tunable laser, an optical amplifier, and a modulator, wherein:
the optical amplifier is coupled between the tunable laser and the modulator; and
the modulator is configured to (i) modulate the output of the optical amplifier with data and (ii) apply the resulting signal to the corresponding input port of the OSF.

8. The invention of claim 1, wherein an optical amplifier is coupled between each receiver and the corresponding output port of the OSF.

9. The invention of claim 1, wherein each optical amplifier is configured to operate in a saturated regime.

10. The invention of claim 1, wherein each optical amplifier is configured to generate steady maximum output power for each wavelength in a range of wavelengths corresponding to optical channels of the OSF.

11. The invention of claim 10, wherein different optical amplifiers are configured to generate different levels of steady maximum output power.

12. The invention of claim 11, wherein the different levels of steady maximum output power are selected based on the insertion loss in the OSF.

13. The invention of claim 11, wherein the different levels of steady maximum output power are selected such that, at each receiver, optical power corresponding to received optical signals from different input ports of the OSF is equalized.

14. The invention of claim 10, wherein, for each optical amplifier, the steady maximum output power is substantially constant over the range of wavelengths corresponding to the optical channels of the OSF.

15. The invention of claim 1, wherein at least one of the M optical amplifiers is a semiconductor optical amplifier (SOA) configured to operate using variable injection current.

16. The invention of claim 15, wherein the SOA is further configured to adjust the variable injection current based on the wavelength of an optical signal applied to the SOA.

17. The invention of claim 1, wherein the OSF is a cyclic arrayed waveguide grating.

18. The invention of claim 1, wherein, for each output port of the OSF, power levels of received optical signals corresponding to different input ports of the OSF are substantially constant.

19. The invention of claim 18, wherein the power levels of the received optical signals corresponding to different output ports of the OSF are substantially constant.

20. A method of transmitting data, comprising the steps of:
(a) applying one or more input optical signals modulated with data to an optical switch fabric (OSF), wherein the OSF has M input ports and M output ports, where M is an integer greater than one;
(b) routing the one or more input optical signals using the OSF to generate one or more output optical signals; and
(c) optically amplifying, using at least M optical amplifiers, one or more optical signals to reduce power variation of received optical signals corresponding to the one or more input optical signals, wherein the received optical signals are based on the one or more output optical signals.

21. The invention of claim 20, wherein step (c) is performed before step (b).

22. The invention of claim 20, wherein step (b) is performed before step (c).

23. The invention of claim 20, wherein each optical amplifier is configured to operate in a saturated regime.

24. The invention of claim 20, wherein each optical amplifier is configured to generate steady maximum output power for each wavelength in a range of wavelengths corresponding to optical channels of the OSF.

25. The invention of claim 24, wherein, for each optical amplifier, the steady maximum output power is substantially constant over the range of wavelengths corresponding to the optical channels of the OSF.

26. The invention of claim 20, wherein at least one of the M optical amplifiers is a semiconductor optical amplifier (SOA) configured to (i) operate using variable injection current and (ii) adjust the variable injection current based on the wavelength of an optical signal applied to the SOA.

27. The invention of claim 20, wherein at least one of the M optical amplifiers is configured to have a gain of about 0 dB.
